(19) United States
(12) Patent Application Publication
(10) Pub. No.: US 2006/0117362 A1
(43) Pub. Date: Jun. 1, 2006

(54) System and method for vision-based security

(76) Inventors: Russell Kennedy Jones III, Palo Alto, CA (US); Mark Somers West, Palo Alto, CA (US); George Mark Miller, Alamo, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/332,417

(22) Filed: Jan. 13, 2006

Related U.S. Application Data
(62) Division of application No. 11/254,295, filed on Oct. 19, 2005.
(60) Provisional application No. 60/620,700, filed on Oct. 20, 2004.

(51) Int. Cl. H04N 7/173; H04N 7/18

(52) U.S. Cl. 725/105; 348/152; 348/155

(57) ABSTRACT

A system and method for arming and disarming a network camera, limiting the number of e-mails sent by the network camera to a user, enabling the network camera to initiate phone calls, transmitting and/or recording video and audio, connecting the network camera to other detection devices, activating a siren, and allowing users to identify themselves within a fixed period of time before taking notification actions. The system and method may be implemented in a device including the network camera.

### RELATED APPLICATIONS

This application is a divisional of U.S. patent application Ser. No. 11/254,295, which claims benefit from U.S. provisional application No. 60/620,700 and is incorporated by reference herein in its entirety.

### BACKGROUND OF THE INVENTION

1. Field of the Invention

The invention relates generally to security systems and, more specifically, security systems using network cameras.

2. Description of Background Art

Network cameras are cameras that typically send their output over a standard local area network through computer networking routers and/or hubs. Once a network camera is installed, an authorized user can access the output of the network camera from any computer that is connected to the local area network using a wired connection or remotely through a connection to the Internet.

Network cameras are commonly used as crude security systems. For example, a user can set up a network camera in view of the entryway of his home and access the camera periodically over the internet to check for signs of disturbance in the entryway. However, this approach is undesirable as it requires the active participation of the user and, should a break-in occur, it is unlikely that the user would be watching the camera at the exact time of the disturbance.

Some network cameras attempt to eliminate the need for ongoing, active user intervention by implementing methods for motion detection. For example, some of these cameras will detect a change in the viewing area by comparing the pixels of a current image with the pixels of a previous image, known as “pixel-by-pixel” comparison. When these network cameras detect a change in pixels above a given threshold, an e-mail is sent to a predetermined e-mail address announcing that motion has occurred in the viewing area of the camera. Some network cameras are also capable of sending e-mail including an image and/or audio from the camera.

While these approaches do reduce the need for ongoing, active user intervention, they also introduce several significant problems. Frequently, motion is detected not due to an actual break-in, but rather by an authorized person or animal moving through the viewing area. A very common example of this kind of false alarm occurs when a pet is moving back and forth across the viewing area, resulting in the generation of hundreds of unnecessary e-mails. Another common problem is that when a user has set up a camera to monitor an entryway, the user himself frequently sets off the motion detection in the course of entrance or egress. Other problems include false alarms due to the sun moving behind the clouds and light bulbs flickering.

The inevitable deluge of false alarms typically results in the e-mails from the network camera quickly losing their value, and, frequently, coming to be ignored entirely. Additionally, standard network cameras, particularly those that send an attached picture, are likely to overflow the user's e-mail inbox with a large amount of irrelevant data, an undesirable result. Furthermore, the high likelihood of false alarms makes it impractical to record or transmit high-bandwidth data, such as streaming video and audio, in the event of an alarm.

Some network cameras attempt to overcome this false alarm problem by determining discrete shapes within the image and limiting motion detection to the movement of certain shapes or within selected viewing areas. Some network cameras have implemented techniques that reduce the likelihood of motion-based false alarms due to pets or other small amounts of motion.

However, these techniques fail to address a serious problem—how to determine whether detected motion was caused by an authorized or unauthorized person. One method for determining if motion is cause for alarm would be to allow authorized users to arm and disarm the system, but existing network cameras have no easy way for the user to arm or disarm the camera. So, for example, while the network camera may successfully avoid a false alarm due to a pet, because there is no easy way to arm and disarm the camera, the same network camera will not avoid a false alarm when the user comes home to feed the pet. Thus there persists a high likelihood of false alarms, resulting in the generation of unnecessary e-mails and making it impractical to record or transmit high-bandwidth data in the event of an alarm.

Existing network cameras are equipped to perform only minimal response in the event of an actual disturbance. The alarm capabilities of existing network cameras are limited to sending e-mail and the storage of event data. Existing network cameras are equipped with no device to scare off intruders such as a siren, and there is no simple way to connect existing network cameras to such a device. They are equipped with no device to notify the user or authority that does not use the internet, such as an interface to a regular telephone line. And they are not capable of receiving alerts from other detection devices, such as smoke or carbon monoxide detectors.

Existing network cameras do not allow for a prioritization of notifications. If an alert is detected, the network camera takes action either immediately or not at all. Existing network cameras are also not capable of responding in different ways to different alarm conditions. Furthermore, existing network cameras are not capable of communicating with professional monitoring services.

What is needed is a network camera that is capable of motion detection, can be armed and disarmed, generates relevant e-mails of reasonable quantity, initiates phone calls or other non-internet alerts, transmits and/or records video and audio, interacts with other detection devices, activates a siren, allows authorized users to identify themselves within a fixed period of time before triggering an alert, prioritizes notifications on the basis of the alarm conditions, and communicates with professional monitoring services.

### SUMMARY OF THE INVENTION

The invention is a system and method for arming and disarming a network camera, limiting the number of e-mails sent by the network camera to a user, enabling the network camera to initiate phone calls, transmitting and/or recording video and audio, connecting the network camera to other detection devices, activating a siren, allowing users to identify themselves within a fixed period of time before taking notification actions, prioritizing notifications on the basis of alarm conditions, and communicating with a professional monitoring service.

### BRIEF DESCRIPTION OF THE DRAWINGS

FIG. 1 is an illustration of a vision-based security system connected to a wide area network and various local devices according to one embodiment of the present invention.

FIG. 2 is an illustration of the components of a vision-based security system according to one embodiment of the present invention.

FIG. 3 is an illustration of a method for processing inbound messages to the vision-based security system according to one embodiment of the present invention.

FIG. 4 is an illustration of a method for responding to alerts triggered by various detection devices according to one embodiment of the present invention.

FIG. 5 is an illustration of a method for determining if an image depicts motion according to one embodiment of the present invention.

FIG. 6 is an illustration of a method for determining if an access code attempt is valid and changing the state of the alarm according to one embodiment of the present invention.

FIG. 7 is an illustration of a method for updating and maintaining a data buffer according to one embodiment of the present invention.

### DETAILED DESCRIPTION OF THE PREFERRED EMBODIMENTS

A preferred embodiment of the present invention is now described with reference to the figures where like reference numbers indicate identical or functionally similar elements. Also in the figures, the left most digits of each reference number corresponds to the figure in which the reference number is first used.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

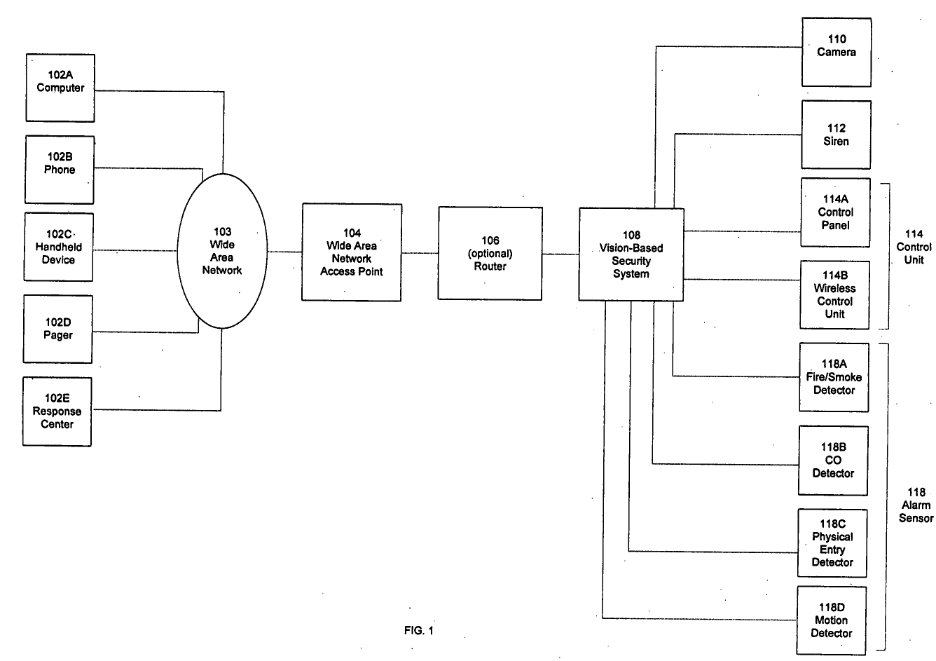

FIG. 1 is an illustration of a vision-based security system connected to a wide area network 103 and various local devices according to one embodiment of the present invention. Also connected to the wide area network 103 are remote devices 102. The remote devices 102 could be one or a combination of devices such as a computer 102A, a phone 102B, a handheld device 102C, or a pager 102D. The remote devices 102 are capable of receiving an electronic message, and in some cases are also capable of sending an electronic message.

The remote devices 102 may also be capable of receiving images and/or audio. Some remote devices 102 may be able to receive streaming video and/or audio in real-time.

The remote devices 102 may be connected to the wide area network 103 either through a wired or a wireless connection. For example, the handheld device 102C may be connected to the wide area network 103 by a wireless connection and be able to receive streaming video through that connection in real-time.

The remote devices 102 may also include a response center 102E. The response center 102E is connected to the wide area network 103 and is capable of taking certain actions in response to messages sent by the vision-based security system 108. For example, the response center 102E may be a facility staffed by professionals trained to respond to certain emergencies. In another embodiment the actions of the response center 102E may be automated using various electronic methods, such as text-to-speech and predetermined e-mail generation. The capability to connect to the response center 102E can improve the usefulness of the vision-based security system 108 in the case of an emergency by enabling contact with police, fire, and other professional services.

The wide area network 103 can be any network enabling a connection between the remote devices 102 and the vision-based security system 108. In one embodiment, the Internet is used as the wide area network 103.

The wide area network access point 104 is connected to the wide area network 103 and the vision-based security system 108. The wide area network access point 104 may be a digital subscriber line modem, an analog modem, a cable modem, a network card, a broadband wireless hub, or any other device for transferring data between the wide area network 103 and the vision-based security system 108. The wide area network access point 104 allows the vision-based security system 108 to be configured remotely and to transmit alerts to the outside world.

The router 106 is connected to the wide area network access point 104 and to the vision-based security system 108. One or both connections may be wireless. The router 106 can facilitate the connection of multiple devices to the wide area network access point 104, or it may connect only the vision-based security system 108 to the wide area network access point 104. The router 106 is optional, and the vision-based security system may be connected directly to the wide area network access point 104.

The vision-based security system 108 is connected to either the router 106, the wide area network access point 104, or both. In one embodiment, this connection may be wireless, but it need not be. The vision-based security system has the capability to send messages to the remote devices 102 over the wide area network 103.

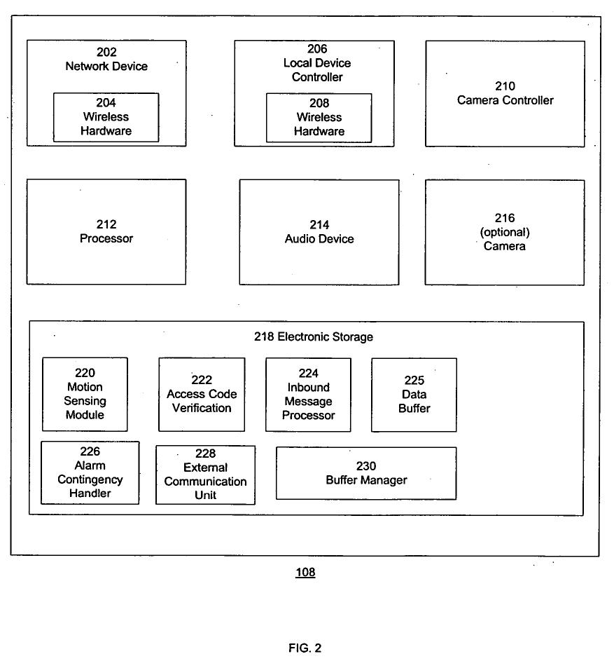

The vision-based security system 108 may also be connected to several local devices. It may be connected to a camera 110, a siren 112, a control unit 114, and an alarm sensor 118. All of these connections may be made wirelessly, but need not be. The vision-based security system 108 will be described in greater detail below with reference to FIG. 2.

The camera 110 is capable of generating a series of images. In one embodiment, the camera 110 is also capable of recording sound. In one embodiment, the camera 110 may be connected to the vision-based security system 108 by the TCP/IP protocol. The camera 110 may be capable of detecting motion in its surrounding areas. The camera 110 may be capable of generating electronic mail messages or streaming audio and/or video over the internet. According to one embodiment of the present invention, the camera may operate in conjunction with a computer, and send a series of images to the vision-based security system 108 via the computer.

According to one embodiment of the present invention, the camera 110 is positioned remotely from the vision-based security system 108. By positioning the camera 110 remotely from the vision-based security system 108, the user can locate the camera 110 in one location while locating the vision-based security system in another. For example, it may be desirable to locate the camera 110 a place of high visibility while safeguarding the vision-based security system 108 in a less conspicuous area. Thus having the camera 110 positioned remotely from the vision-based security system 108 increases the flexibility and usefulness of the vision-based security system.

In another embodiment, the camera 110 is embodied in the vision-based security system 108.

In one embodiment, the siren 112 is capable of producing sound. The siren 112 may have multiple volumes and/or modes. In another embodiment, the siren 112 may be a visual siren. The siren 112 allows the vision-based security system 108 to scare off intruders, alert neighbors and residents of danger, and to signal alarm status to the user.

The choice of the siren 112 as an alarm device is made for purposes of illustration and does not limit the scope of the invention. One skilled in the art will recognize that any one of the many commonly available alarm devices could be used. For example, devices such as audible sirens, visual sirens, strobe lights, and automatic door locks are all alarm devices that could be used in various embodiments of the invention.

The control unit 114 is capable of receiving user input. The control unit 114 may be a fixed or portable input pad such as a control panel 114A, or it may be a wireless control unit 114B. The wireless control unit 114B may be equipped with a radio transceiver for communicating with the vision-based security system 108. The control unit 114 allows the user to arm and disarm the vision-based security system 108 easily, and without the need of an external input device such as a computer. The control unit 114 may also be equipped with a panic button to initiate certain alarm procedures quickly in the event of an emergency.

The wireless control unit 114B may also use Radio Frequency Identification (RFID) technology or other active or passive techniques for transmitting information to the vision-based security system 108. When the wireless control unit 114B is equipped with RFID technology, the user could control the vision-based security system 108 by holding the wireless control unit 114B in a designated RFID-reading location.

The alarm sensor 118 is capable of detecting a condition and reporting it to the vision-based security system 108. The alarm sensor 118 may be a smoke detector 118A, a carbon monoxide detector 118B, a physical entry detector 118C, or a motion detector 118D. One skilled in the art will recognize that the alarm sensor 118 may be any detector capable of reporting a condition of potential interest. For example, the alarm sensor 118 may be a sensor such as a glass break sensor, a door sensor, or a window sensor. The vision-based security system 108 is responsive to the alarm sensor 118 and can take action in the event the alarm sensor 118 reports a condition of concern. The alarm sensor 118 allows the vision-based security system 108 to monitor and respond to physical inputs in addition to the camera 110, increasing the comprehensiveness and effectiveness of the vision-based security system 108.

FIG. 2 is an illustration of the components of a vision-based security system according to one embodiment of the present invention. The network device 202 can be any one of a variety of conventional devices for establishing a network connection to either the router 106 or the wide area network access point 104. The network device 202 can be an Ethernet card. The network device 202 can also be equipped with wireless hardware 204 for establishing a wireless connection to either the router 106 or the wide area network access point 104.

The local device controller 206 can be connected to any of the siren 112, the control unit 114, and the alarm sensor 118. The local device controller 206 may be equipped with wireless hardware 208 for establishing these connections wirelessly. The wireless hardware 208 can include an RFID tag reader, or other radio devices for transmitting and/or receiving data wirelessly. Such technology can increase the convenience of arming, disarming, or otherwise controlling the vision-based security system 108 for the user.

The camera controller 210 is connected to the camera 110. The camera controller 210 receives images from the camera 110 and relays them to the buffer manager 230. In some embodiments the camera controller 210 also receives audio and/or e-mail messages from the camera 110.

The processor 212 can be implemented using one of many available processors, such as the Motorola 68000 series microprocessor or an Arm 9 microprocessor, for example. The processor 212 manages remote control devices, generates outgoing messages, and coordinates input from the camera by executing one of several programs in the 218 electronic storage. More explanation regarding these programs is set forth herein.

The optional audio device 214 may include hardware for either input or output or both. The input hardware may include a microphone, or it may include a connector for receiving audio in an electronic form. The audio input may be transmitted as streaming audio over the wide area network 103, or it may be sent to the buffer manager 230. The output hardware may include a speaker, or it may include a connector for transmitting audio in an electronic form. The audio output may be used to amplify text-to-speech signals to communicate information to the user or warnings to potential intruders. The audio output may also be used to supplement the siren 112.

The camera 216 is optional. In one embodiment the camera 110 is embodied in the vision-based security system 108, and the camera 110 is functionally equivalent to the camera 216. In another embodiment the camera 216 is used in conjunction with the physically separate camera 110.

The electronic storage 218 is a computer readable medium accessible by the processor. The electronic storage 218 comprises the motion sensing module 220, the access code verification 222, the inbound message processor 224, the data buffer 225, the alarm contingency handler 226, the external communication unit 228, and the buffer manager 230.

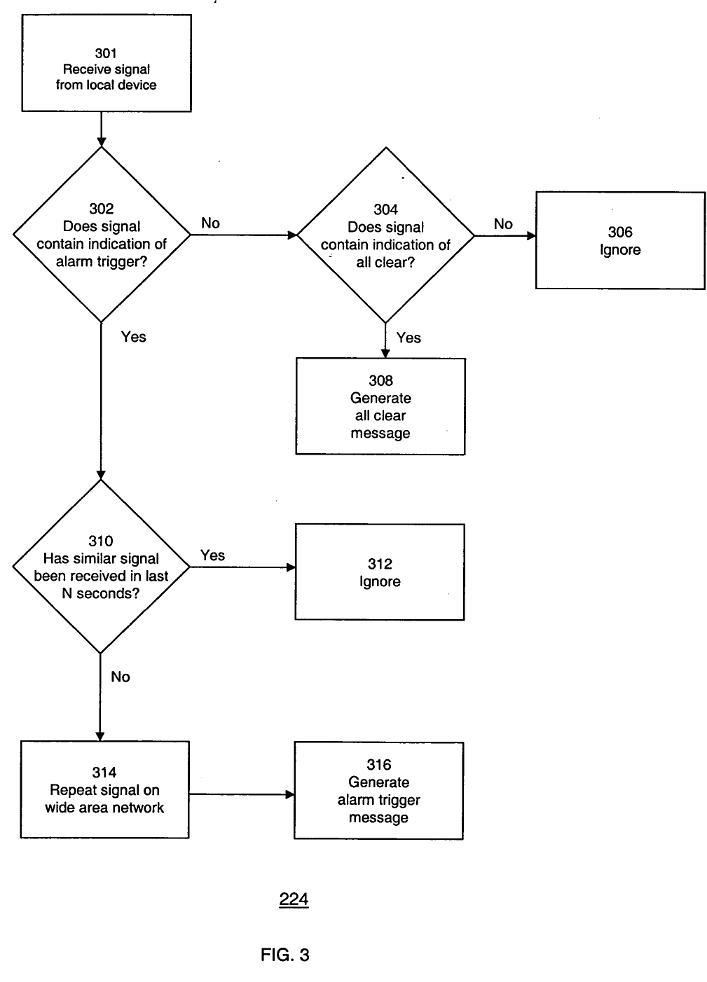

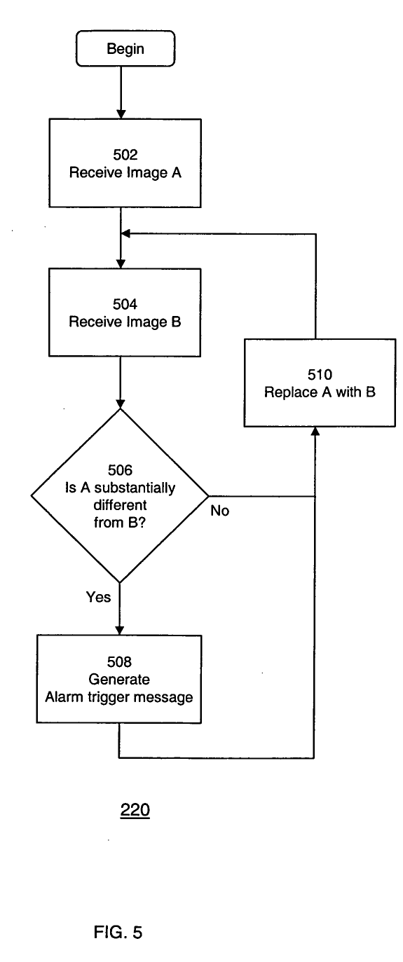

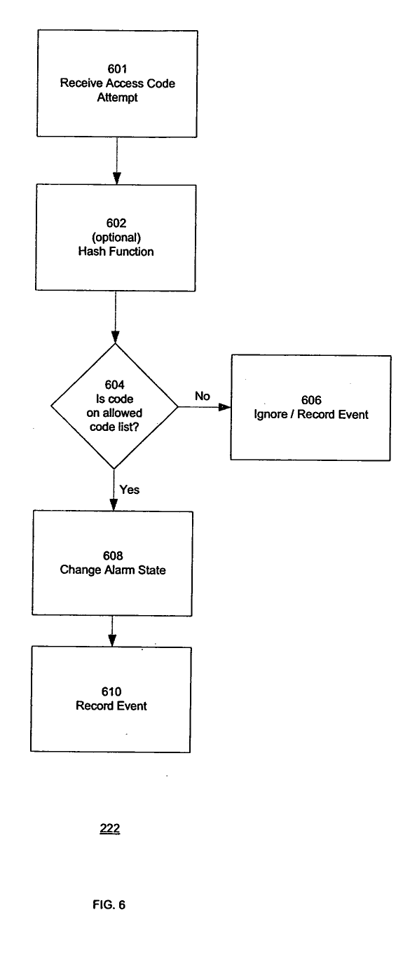

The method used by the motion sensing module 220, according to one embodiment of the present invention, is illustrated in greater detail in FIG. 5. The method used by the access code verification 222, according to one embodiment of the present invention, is illustrated in greater detail in FIG. 6. The method used by the inbound message processor 224, according to one embodiment of the present invention, is illustrated in greater detail in FIG. 3.

The data buffer 225 is capable of storing video and/or audio data and is accessible by the buffer manager 230 and the external communication unit 228.

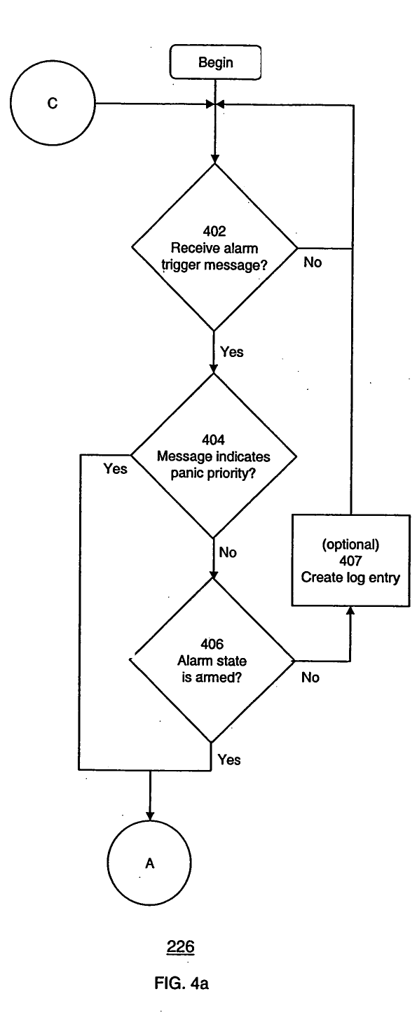

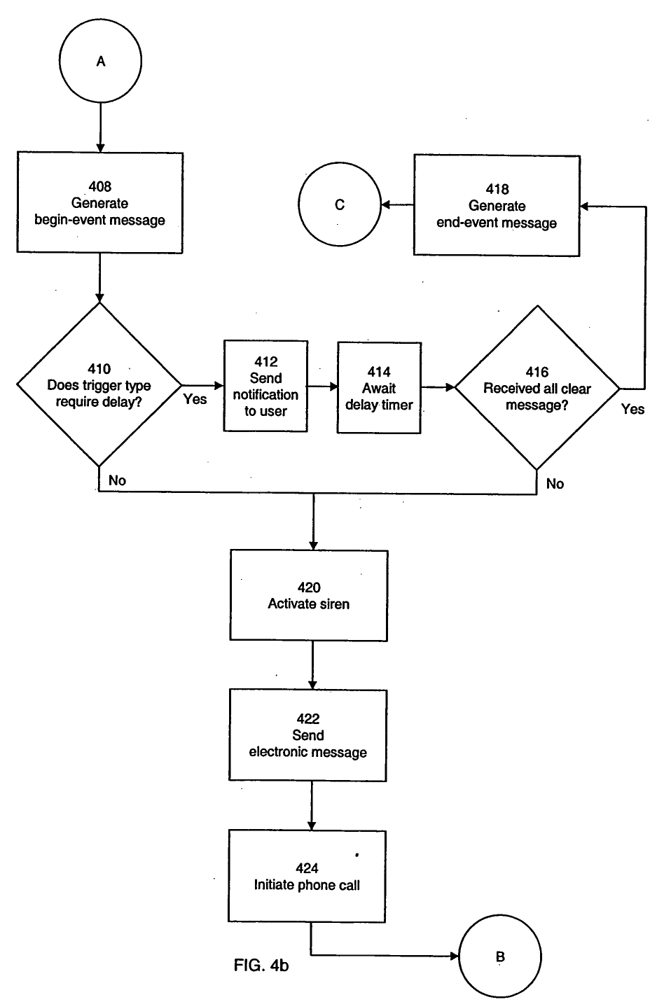

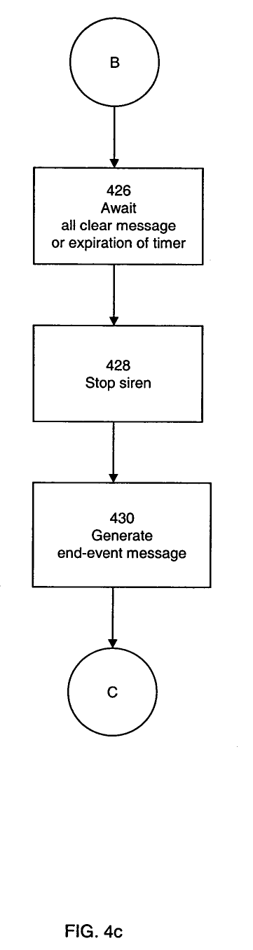

The method used by the alarm contingency handler 226, according to one embodiment of the present invention, is illustrated in greater detail in FIG. 4.

The external communication unit 228 is capable of generating messages to be sent by the network device 202 to the remote devices 102. The external communication unit 228 generates e-mail messages, and, in one embodiment, initiates voice over internet protocol (VOIP) phone calls. The external communication unit 228 is also capable of streaming audio and/or video from the data buffer 225 over the wide area network 103. The external communication unit 228 allows the vision-based security system 108 to generate meaningful data messages for transmittal to the remote devices 102.

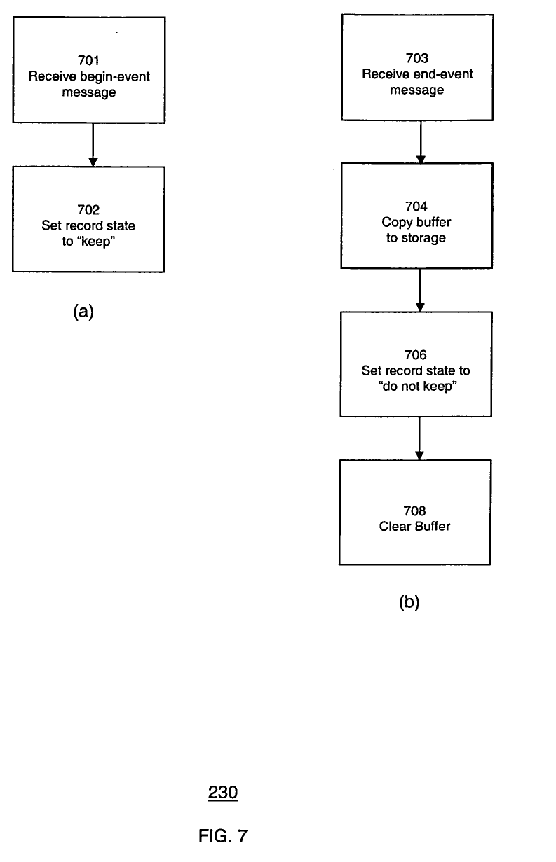

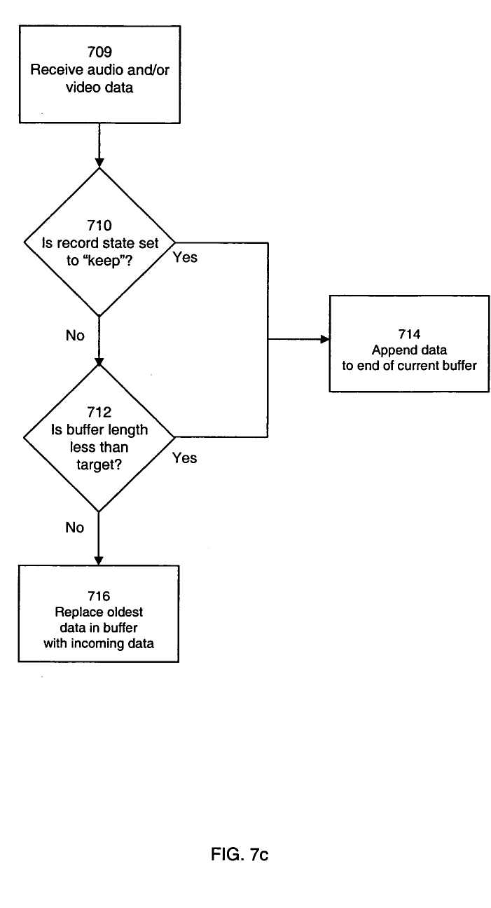

The method used by the buffer manager 230, according to one embodiment of the present invention, is illustrated in greater detail in FIG. 7.

FIG. 3 is an illustration of a method for processing inbound messages to the vision-based security system according to one embodiment of the present invention. In one embodiment the method is performed by the inbound message processor 224. The inbound message processor 224 begins by receiving 301 a signal from a local device from either the local device controller 206, the motion sensing module 210, or the camera controller 210. The inbound message processor 224 determines 302 if the signal contains an indication of an alarm trigger. For example, an indication of alarm trigger could be motion detected in the images from the camera 110, a signal from an alarm sensor 118, or a panic message from the control unit 114.

If the determination 302 is positive, the inbound message processor 224 determines 310 if a similar signal has been received within the last N seconds, where N is a predetermined number, which in one embodiment can be modified. If the determination 310 is positive, the inbound message processor 224 ignores 312 the signal. If the determination 310 is negative, the inbound message processor 224 generates 316 an alarm trigger message. Alarm trigger messages are control signals sent to the alarm contingency handler 226. Optionally, if the received signal is a message generated by the camera 110, the inbound message processor 224 repeats 314 the signal on the wide area network 103.

If the determination 302 is negative, the inbound message processor 224 determines 304 if the signal contains an indication of all-clear. For example, an indication of all-clear could be the alarm sensor 118 signaling a return to normal state or the control unit 114 signaling that the system has been disarmed.

If the determination 304 is positive, the inbound message processor 224 generates 308 an all-clear message. All-clear messages are control signals sent to the alarm contingency handler 226. If the determination 304 is negative, the inbound message processor 224 ignores 306 the signal.

FIG. 4 illustrates a method for responding to alerts triggered by various detection devices according to one embodiment of the present invention. In one embodiment the method is performed by the alarm contingency handler 226. The alarm contingency handler 226 begins by looping until the alarm contingency handler 226 determines 402 that an alarm trigger message has been received.

Once the alarm contingency handler 226 determines 402 that an alarm trigger message has been received, the alarm contingency handler 226 determines 404 if the alarm was sent with panic priority. For example, the control unit 114 may have a button to sound an alarm immediately for indicating an alarm condition that merits higher or “panic” priority. Alarms sent with panic priority typically supersede the armed/disarmed state of the system and are handled without delay.

If the alarm contingency handler 226 determines 404 that the alarm was not sent with panic priority, the alarm contingency handler 226 determines 406 if the system is in an armed alarm state. If the alarm contingency handler 226 determines 406 that the system is not in an armed alarm state, the alarm contingency handler 226 returns to the beginning of the loop. According to one embodiment of the present invention, the alarm contingency handler 226 also creates 407 a log entry detailing the date, time, and circumstances of the received alarm trigger message.

If the alarm contingency handler 226 determines 406 that the system is in an armed alarm state, the alarm contingency handler 226 generates 408 a begin-event message. Begin-event messages are control signals sent to the buffer manager 230. More detail about the various alarm states will be described herein with reference to FIG. 6.

If the alarm contingency handler 226 determines 404 that the alarm message was sent with panic priority, it is not necessary to determine the alarm state of the system, and the alarm contingency handler 226 generates 408 a begin-event message.

The illustration of the method for responding to alerts triggered by various detection devices, according to one embodiment of the present invention, continues on FIG. 4b.

After generating 408 the begin-event message, the alarm contingency handler 226 determines 410 if the trigger type requires a delay. The alarm contingency handler 226 may use user-defined rules to make the determination 410. For example, the user may have set a delay for when the alarm signal originates from the physical entry detector 118C or from the motion sensing module 220, but not for when the alarm signal originates from a panic button or the smoke detector 118A. In this case an alarm from the motion sensing module 220 would be determined 410 to require a delay while an alarm from the smoke detector 118A would be determined 410 to not require a delay. These rules can be established ahead of time by user preference. According to one embodiment of the present invention, these rules can be modified by the user.

If the alarm contingency handler 226 determines 410 that the trigger type does require a delay, the alarm contingency handler 226 optionally sends 412 notification to the user that an alarm has been triggered. The notification could be of any form that would alert the user that an alarm has been triggered and that the siren will sound momentarily if further action is not taken. For example, the notification could be an e-mail generated by the external communication unit 228, a steady, medium-volume tone generated by the siren 112, or warning message played by the audio device 214. By notifying 412 the user after an alarm has been triggered but before the siren is activated 420, the vision-based security system 108 gives the user the opportunity to resolve the alarm condition before further action is taken.

The alarm contingency handler 226 awaits 414 the delay timer and, after the timer has expired, determines 416 if an all-clear message has been received. If the alarm contingency handler 226 determines 416 that an all-clear message has been received, the alarm contingency handler 226 generates 418 an end-event message and returns to the beginning. End-event messages are control signals sent, for example, to the buffer manager 230. By allowing the user a predetermined amount of time to respond to an alarm condition, the vision-based security system 108 reduces the likelihood of false alarms and increases ease of operation for the user.

If the alarm contingency handler 226 determines 416 that no all-clear message has been received, the alarm contingency handler 226 activates 420 the siren 112.

If the alarm contingency handler 226 determines 410 that the trigger type does not require a delay, the alarm contingency handler 226 activates 420 the siren 112 directly without the intervening sending of notification 412 and delaying 414.

The alarm contingency handler 226 sends 422 an electronic message using the external communication unit 228. The electronic message could be an e-mail to a predetermined list of addresses, a text message to a phone 102B or handheld device 102C, or a direct data transfer with a computer 102A or a response center 102E. The electronic message could also contain images and/or audio. The procedure for sending 422 an electronic message could be established ahead of time by the user. Configuring the procedures for sending electronic messages allows the user to customize the alarm response to his needs.

The alarm contingency handler 226 initiates 424 a phone call using a predetermined list of phone numbers. According to one embodiment of the present invention, the list of phone numbers used by the alarm contingency handler 226 is modifiable by the user. The phone call can be made using a standard telephone line, for example, if the network device 202 includes a modem, or VOIP. The step of initiating 424 a phone call provides an additional method of notifying the user or the authorities, as well as a back-up measure for notification in the case of wide area network 103 failure.

The illustration of the method for responding to alerts triggered by various detection devices, according to one embodiment of the present invention, continues on FIG. 4c.

The alarm contingency handler 226 awaits 426 an all-clear message or the expiration of a timer. The alarm contingency handler 226 stops 428 the siren 112 if an all-clear message is received, but can also stop 428 the siren 112 after a predetermined amount of time if no all-clear message is received. Stopping 428 the siren 112 after a predetermined amount of time prevents unneeded waste of energy and annoyance of neighbors in the event the user is on an extended absence.

The alarm contingency handler 226 generates 430 an end-event message and returns to the beginning.

FIG. 5 is an illustration of a method for determining if an image depicts motion according to one embodiment of the present invention. In one embodiment, the method is performed by the motion sensing module 220. Detecting motion is a feature of the operation of the vision-based security system because it removes the need for the user to actively monitor the camera.

Motion detection can be accomplished in many different ways. One skilled in the art will recognize that other image-processing methods can be implemented for detecting motion without departing from the scope of the present invention, and that the method described herein is simply one of many acceptable approaches.

The motion sensing module 220 receives 502 image A and receives 504 image B.

The motion sensing module 220 determines 506 if image A is substantially different from image B. The determination 506 could be made using pixel-by-pixel comparison or other techniques for detecting changes in two image frames.

If the motion sensing module 220 determines 506 that image A is substantially different from image B, the motion sensing module 220 generates 508 an alarm-trigger message. Alarm-trigger messages are control signals that are sent to the inbound message processor 224.

The motion sensing module 220 replaces 510 image A with image B and returns to receive 504 a new image B.

FIG. 6 is an illustration of a method for determining if an access code attempt is valid and changing the state of the alarm according to one embodiment of the present invention. In one embodiment the method is performed by the access code verification 222. A component of the vision-based security system 108 is the ability to have at least an armed and disarmed alarm state and to respond to various alarm conditions appropriately on the basis of that state.

The access code verification 222 begins by receiving 601 an access code attempt from either the external communication unit 228 or the control unit 114. The access code attempt is a signal intended to change the alarm state of the system. However, because the security of the system can be compromised by unauthorized attempts to change the alarm state, code verification is desirable.

The access code verification 222 optionally performs 602 a mathematical hash function on the access code attempt. The hash function can be any one of many well-known methods for converting an input to an output in a difficult-to-reverse manner.

The access code verification 222 compares the access code attempted (or the output of the hash function, if the hash function 602 is implemented) to a list of allowed codes. For example, if the access code attempt originated at a wireless control unit 114B, the wireless signal can include a code or signature identifying the wireless control unit 114B in question. This code can be searched for in a list of known and authorized codes. The code list can be configured by the user to include multiple codes, as well as codes with one-time or limited-duration use.

If the access code verification 222 determines 604 that the code is on the allowed list, the access code verification 222 changes 608 the alarm state as indicated in the access code attempt and, optionally records 610 the event with access code, time, and date information. Recording 610 the event allows the user to verify access attempts and monitor the status of the system. According to one embodiment of the present invention, the access code verification 222 sends a message to the user when an access code attempt is made.

In one embodiment the access code attempt specifies whether to arm or disarm the system, and instructions to change the alarm state to the state it is already in are ignored. In another embodiment, the access code attempt does not specify whether to arm or disarm, and the alarm state alternates between armed and disarmed states in a binary fashion whenever an access code attempt is received.

In yet another embodiment, the system has a plurality of alarm states and the access code attempt contains an indication of the desired alarm state. According to one embodiment of the present invention, the system has three alarm states: armed, disarmed, and panic. Messages sent with panic priority change the alarm state of the system to panic, resulting in immediate alarm action such as initiating siren, generating e-mail messages, and recording audio and/or video. Subsequent access code attempts may return the alarm to either the armed or disarmed states. By having a third alarm state for panic priority situations, the system is capable of prioritizing alarm actions. According to another embodiment of the present invention, if a message is received with panic priority the system transitions immeditately to the armed state and the alarm is activated.

If the access code verification 222 determines 604 that the code is not on the allowed list, the access code verification 222 ignores or records 606 the erroneous access code attempt. According to one embodiment of the present invention, the access code verification 222 sends a message to the user reporting the erroneous access code attempt.

FIG. 7 is an illustration of a method for updating and maintaining a data buffer according to one embodiment of the present invention. In one embodiment the method is performed by the buffer manager 230. The buffer manager 230 is responsive to begin-event messages, end-event messages, and the reception of audio and/or video data.

FIG. 7a illustrates the response to receiving 701 a begin-event message according to one embodiment of the present invention. The buffer manager 230 sets 702 the record state to “keep”. The record state is an internal state used by the data buffer manager 230 to coordinate the storage and disposal of buffer data.

FIG. 7b illustrates the response to receiving 703 an end-event message according to one embodiment of the present invention. The buffer manager 230 optionally copies 704 the current data buffer 225 to a separate area of the electronic storage 218 for archiving. Alternatively, the buffer manager 230 can transfer the content of the data buffer 225 to another location by sending the content to the external communication unit 228.

The buffer manager 230 sets 706 the record state to “do not keep”.

The buffer manager 230 clears 708 the data buffer 225.

FIG. 7c illustrates the response to receiving 709 audio and/or video data according to one embodiment of the present invention. The buffer manager 230 determines 710 if the record state is set to “keep”. If the determination 710 is positive, the buffer manager 230 appends 714 the incoming data to the end of the current buffer. Thus, if the record state is “keep” the buffer manager 230 stores all incoming data without recording over any existing data.

If the buffer manager 230 determines 710 that the record state is not set to “keep”, the buffer manager 230 determines 712 if the buffer length is less than some predetermined target. If the determination is positive, the buffer manager 230 appends 714 the incoming data to the end of the current buffer. This case usually occurs when the buffer has recently been cleared, and causes the buffer to be filled to a predetermined target length.

If the buffer manager 230 determines 712 that the buffer length is equal to or greater than some predetermined target, the buffer manager 230 replaces 716 the oldest data in the buffer with the current data. So if the buffer has reached the predetermined target length and the record state is not set to “keep”, the buffer manager 230 maintains a buffer of constant size filled with only the most recent data entries.

The data buffer manager 230 is beneficial for the operation of the vision-based security system 108 as it ensures that incoming audio and/or video data is recorded in the event of an alarm trigger. Furthermore, the data buffer manager 230 has the advanced functionality of so-called “pre-trip” buffer recording. The data buffer manager 230 is continuously recording incoming data. Under normal circumstances, this data is overwritten after some predetermined amount of time in the buffer. However, when an alarm trigger occurs and a begin-event message is received from the alarm contingency handler 226, the existing contents of the buffer are no longer allowed to be overwritten. The buffer manager 230 therefore allows the storage of events that occurred before the alarm was triggered.

For example, consider a buffer that continuously allows ten seconds of video to be stored in the buffer. If an alarm trigger occurs, the resulting recording of the event will include audio and/or video of the ten seconds prior to the alarm trigger as well as video taken during and after the event itself.

Thus a user who, at the moment of the alarm trigger, starts watching the recording at the beginning of the buffer, will be watching events several moments behind real-time. In one embodiment, the user would have the option to either maintain this lag or to skip forward to real-time.

The buffer manager 230 may also be equipped to handle cases of buffer overflow, to periodically move data to another buffer, and to perform other data management tasks as desired.

While the invention has been particularly shown and described with reference to a preferred embodiment and several alternate embodiments, it will be understood by persons skilled in the relevant art that various changes in form and details can be made therein without departing from the spirit and scope of the invention.

What is claimed is:

1. A system for vision-based security comprising:
a network camera for receiving a plurality of images, and outputting a video signal representing said plurality of images; and
a first device, including said network camera and disposed to receive said video signal from said network camera for detecting motion in said plurality of images, said first device having a first state that is modifiable by the user and is one of an armed state, a panic-mode state, or a disarmed state, and, when motion is detected in said plurality of images and said first state is in said armed state, said first device generating a motion message, addressing said motion message to a remote device, and transmitting said motion message over a wide area network.

2. The system of claim 1, wherein said network camera is capable of generating TCP/IP messages and wherein said first device is a TCP/IP-capable device.

3. The system of claim 1, wherein said first state is responsive to an input received from a control device.

4. The system of claim 3, wherein said input from said control device is received wirelessly.

5. The system of claim 1, additionally comprising an alarm device capable of generating an alarm in response to an alarm signal, wherein said first device, when motion is detected in said plurality of images and said first state is in said armed state, transmits said alarm signal to said alarm device.

6. The system of claim 5, wherein said alarm device is a siren.

7. The system of claim 5, wherein said alarm signal is transmitted to said alarm device wirelessly.

8. The system of claim 1, wherein said motion message is an electronic mail message.

9. The system of claim 1, wherein said motion message comprises said video signal.

10. The system of claim 1, wherein said first device buffers said video signal received from said network camera.

11. The system of claim 1, further comprising a microphone disposed to transmit an audio signal to said first device.

12. The system of claim 11, wherein said motion message includes said audio signal.

13. The system of claim 11, wherein said first device buffers said audio signal.

14. The system of claim 1, further comprising a local detector device disposed to transmit a warning signal to said first device.

15. The system of claim 14, wherein said local detector device is one of a carbon monoxide detector, smoke detector, motion detector, entry detector, water detector, glass break detector, or door detector.

16. The system of claim 14, wherein said warning signal from said local detector device is transmitted wirelessly.

17. A method for vision-based security having a network camera included in a first device, comprising the steps of:
receiving a plurality of images, by the network camera, and transmitting a video signal, representing said plurality of images, from the network camera to the first device;
detecting motion in said plurality of images;
identifying a first state as being one of an armed state, a panic-mode state or a disarmed state, said first state modifiable by a user;
generating a motion message when motion is detected in said plurality of images and said first state is in said armed state;
addressing said motion message to a remote device; and
transmitting said motion message from the first device to a wide area network.

18. The method of claim 17, wherein the network camera is capable of generating TCP/IP messages and wherein the first device is a TCP/IP-capable device.

19. The method of claim 17, wherein said first state is responsive to an input received from a control device.

20. The method of claim 19, wherein said input from said control device is received wirelessly.

21. The method of claim 17, further comprising the steps of:
generating an alarm signal when motion is detected in said plurality of images and said first state is in said armed state; and
transmitting said alarm signal to an alarm device capable of generating an alarm in response to said alarm signal.

22. The method of claim 21, wherein said alarm device is a siren.

23. The method of claim 21, wherein said alarm signal is transmitted to said alarm device wirelessly.

24. The method of claim 17, wherein said motion message is an electronic mail message.

25. The method of claim 17, wherein said motion message comprises the video signal.

26. The method of claim 17, further comprising the step of buffering said video signal.

27. The method of claim 17, further comprising the step of receiving an audio signal through a microphone.

28. The method of claim 27, wherein said motion message includes said audio signal.

29. The method of claim 27, further comprising the step of buffering said audio signal.

30. The method of claim 17, further comprising the step of receiving a warning signal from a local detector device.

31. The method of claim 30, wherein said local detector device is one of a carbon monoxide detector, smoke detector, motion detector, entry detector, water detector, glass break detector, or door detector.

32. The method of claim 30, wherein said warning signal from said local detector device is received wirelessly.
